(19) United States
(12) Patent Application Publication
(10) Pub. No.: US 2014/0131648 A1
(43) Pub. Date: May 15, 2014

(54) Drive-through Gate Assembly

(71) Applicant: William F. Gottsleben, Philip, SD (US)

(72) Inventor: William F. Gottsleben, Philip, SD (US)

(21) Appl. No.: 13/672,814

(22) Filed: Nov. 9, 2012

(51) Int. Cl. E06B 11/02

(52) U.S. Cl. CPC E06B 11/027
USPC 256/73

(57) ABSTRACT

A drive-through gate assembly for vehicles is provided in which a gate is positioned in a rectangular gate frame. The gate is hinged to the frame bottom with the gate being rotatable from a gate position flat on the ground surface on one side of the gate assembly to an upright position to a gate position flat on the ground surface on the other side of the gate assembly. A spring pulls the gate upright when a vehicle is not resting on the down gate and a flexible means attached to the gate top slows gate movement as the gate reaches the upright position

### BACKGROUND OF THE INVENTION

1. Field of the Invention

This invention relates to gates for vehicles, and in particular, pertains to a drive-through gate assembly for use by ATVs and other vehicles.

2. Description of the Related Art

In rural areas, property is often surrounded by fences to contain or keep out animals such as cattle and horses. Gates spaced periodically along the fences are often used to allow vehicles such as tractors or other farm vehicles to go in and out of the fenced areas. All-terrain vehicles (ATVs) are designed to traverse great distances across fields or other areas which are often bordered or crossed by fences. ATVs are also used by ranchers to travel across fields, as well as on farm roads to gain access to remote areas. In recreational areas, persons riding on ATVs are often allowed to quickly traverse large uneven terrain areas. When such ATVs or other vehicles arrive at gates in fences; however, the drivers must dismount, open the gate, get back on the vehicle, drive through, dismount again to close the gate, and then get back on the vehicle and proceed to the next gate and repeat. This not only consumes time but is a great inconvenience to the driver. Also, because the driver cannot be both on the vehicle and near the gate to keep livestock from going through the gate opening, there can be problems of livestock escaping to areas where they should not be.

Prior attempts to address this problem include the Berg ATV QUICK PASS GATE™, which is an elevated cattle-guard-like ramp over which an ATV can pass, but which cattle cannot negotiate.

The AUTO QUADGATE™ (U.S. Patent Application Publication No. 2011/0108790) opens automatically when a vehicle goes up ramp members and pushes against the gate. There is a gate frame that opens about a vertical pivot axis and which is secured to a post by a sliding bar. The ramp members can be folded upright so that the gate and the gate frame can be opened to form a larger opening. This gate also has a spring gate return, as well as a pair of latch members on the gate that are received by latch finger members. The lower bar at the bottom of the gate is received in U-shaped channels on the frame so that when a vehicle passes up the ramp members, the lower bar of the gate is pushed downward in the U-shaped channels to a lower position, and when the vehicle has passed over the ramp members, the gate member is pivoted upright to its closed position and the lower bar of the gate is pulled into an upper position in the U-shaped channels by spring action.

It is an object of the invention herein to provide a substantially simpler gate for allowing an ATV or other vehicle to cross a fence without the driver needing to leave the vehicle, and which doses automatically and slows and ultimately stops in an upright position without the need for latches.

Other objects and advantages will be more fully apparent from the following disclosure and appended claims.

### SUMMARY OF THE INVENTION

The invention herein is a drive-through gate assembly for vehicles in which a gate is positioned in a rectangular gate flame. The gate is hinged to the frame bottom with the gate being rotatable from a gate position flat on the ground surface on one side of the gate assembly to an upright position to a gate position flat on the ground surface on the other side of the gate assembly. A spring pulls the gate upright when a vehicle is not resting on the down gate and a flexible means attached to the gate top slows gate movement as the gate reaches the upright position.

Other objects and features of the inventions will be more fully apparent from the following disclosure and appended claims.

### BRIEF DESCRIPTION OF THE DRAWINGS

FIG. 1 is an elevational view of the drive-through gate assembly of the invention.

FIG. 2 is a front elevational view of the drive-through gate assembly of FIG. 1 showing an approaching vehicle.

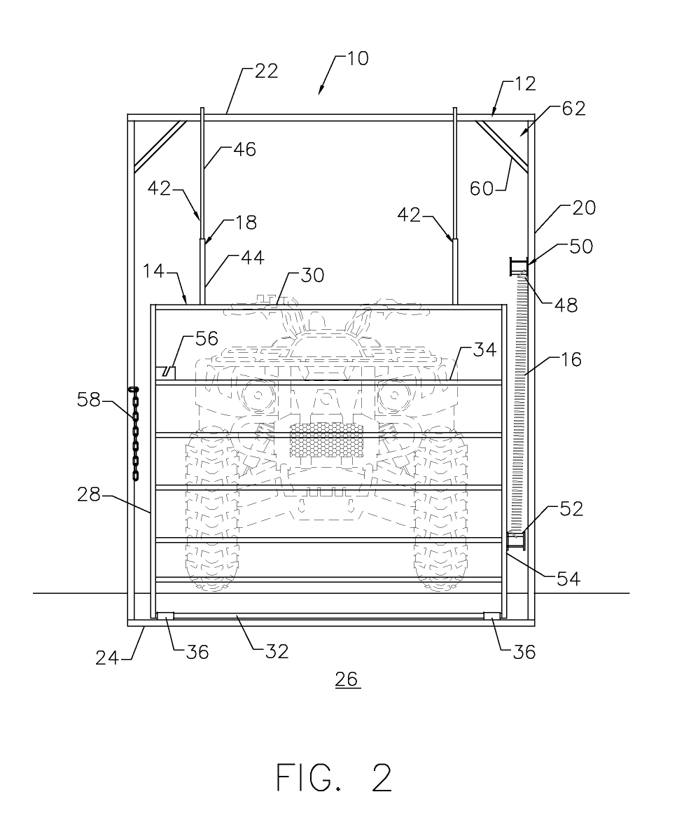

FIG. 3 is a schematic side view of the drive-through gate assembly of FIG. 1, showing several possible positions of the gate within the frame.

FIG. 4 is a side perspective view of a gate of the drive-through gate assembly of FIG. 1.

FIG. 5 is a side perspective view of the drive-through gate assembly of the invention with the gate partly lowered.

FIG. 6 is a side elevational view of a vehicle lowering a gate of the invention.

FIG. 7 is a front elevational view of a vehicle on a gate of the invention that has been lowered.

FIG. 8 is a partial perspective cutaway view of the bottom of a drive-through gate assembly of the invention.

### DETAILED DESCRIPTION OF THE INVENTION AND PREFERRED EMBODIMENTS THEREOF

The present invention is a drive-through gate assembly. In its preferred embodiment, the drive-through gate assembly of the invention herein is sized for use by ATVs and similar sized-vehicles; however, the size of the invention may be varied for use by other sizes of vehicles without departing from the invention herein. For substantially larger vehicles, for example, it is clear that the size of the gate and gate frame would need to be increased and more heavy duty materials would be preferable. Dimensions given herein for components of the invention are those used in a preferred embodiment, and variations in dimensions to accommodate different sized vehicles and gates as well as individual preferences are within the scope of the invention herein.

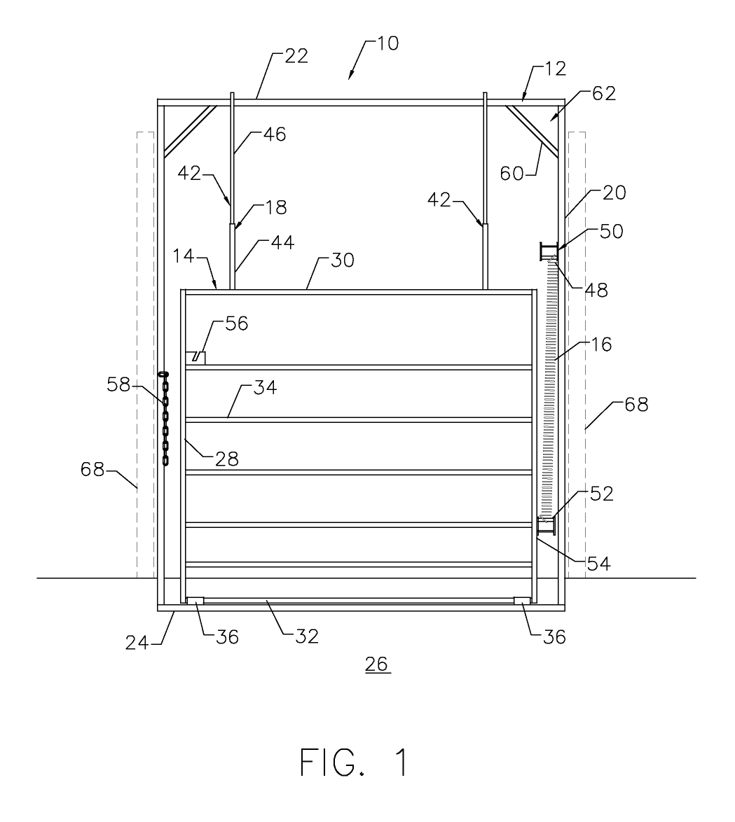

Referring now to the figures, the drive-through gate assembly 10 (FIGS. 1, 4-8) of the invention comprises a gate frame 12 inside which a gate 14 is mounted as discussed in more detail herein so that a vehicle that approaches and pushes against the gate 14 causes the gate 14 to be pushed downward in front of the vehicle and be opened so that the vehicle can pass through the gate frame 12. The opened gate 14 lies flat on the ground surface adjacent the drive-through gate assembly 10 beneath the vehicle as the vehicle drives through the gate frame 12. When the vehicle has progressed off of the gate 14, the gate 14 is drawn upward by a spring 16 to an upright position. The gate 14 is kept from going beyond the upright position by flexible means.

The drive-through gate assembly specifically comprises a rectangular gate frame 12 having two frame sides 20, a frame top 22 and a frame bottom 24 positioned on a ground surface 26 (FIG. 1). The rectangular gate 14 has two gates sides 28, a gate top 30, a gate bottom 32, a plurality of horizontal gate crossbars 34, and preferably at least one vertical crossbar 35. The gate 14 is dimensioned so that it fits within the gate frame 12 as discussed in more detail below.

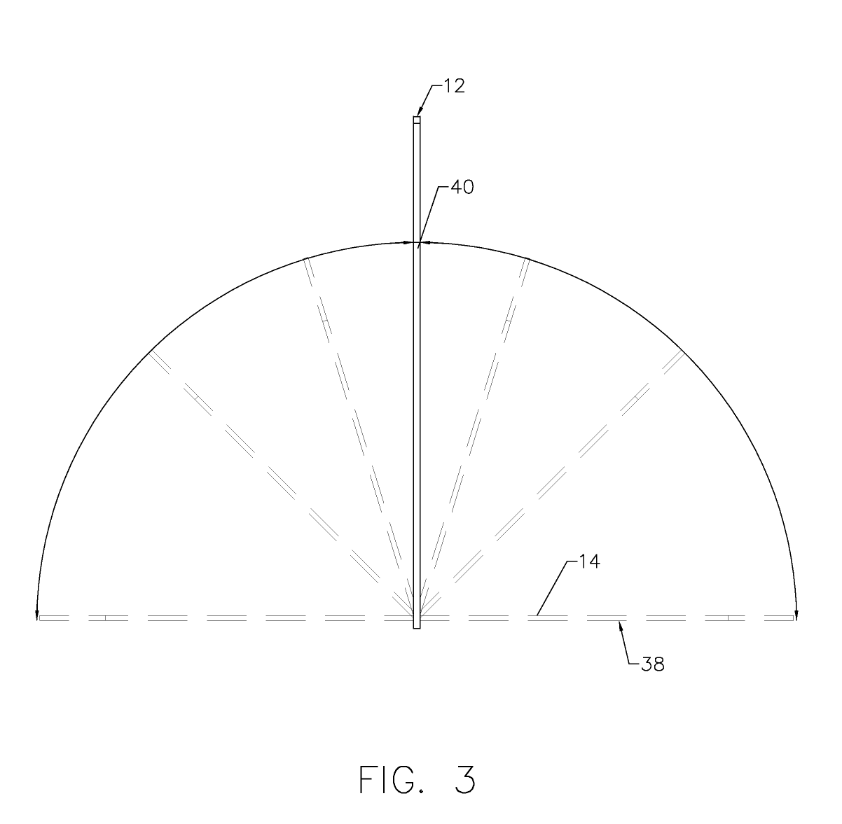

The gate 14 is attached to the gate frame 12 by a means of hinging 36 the gate bottom 32 to the frame bottom 24 so that the gate 14 is rotatable within the means of hinging 36 the gate bottom 32 to the frame bottom 24, from a horizontal gate position 38 flat on the ground surface 26 on one side of the gate assembly 10 to an upright gate position 40 to a horizontal gate position 38 flat on the ground surface 26 on the other side of the gate assembly 10 (FIG. 3).

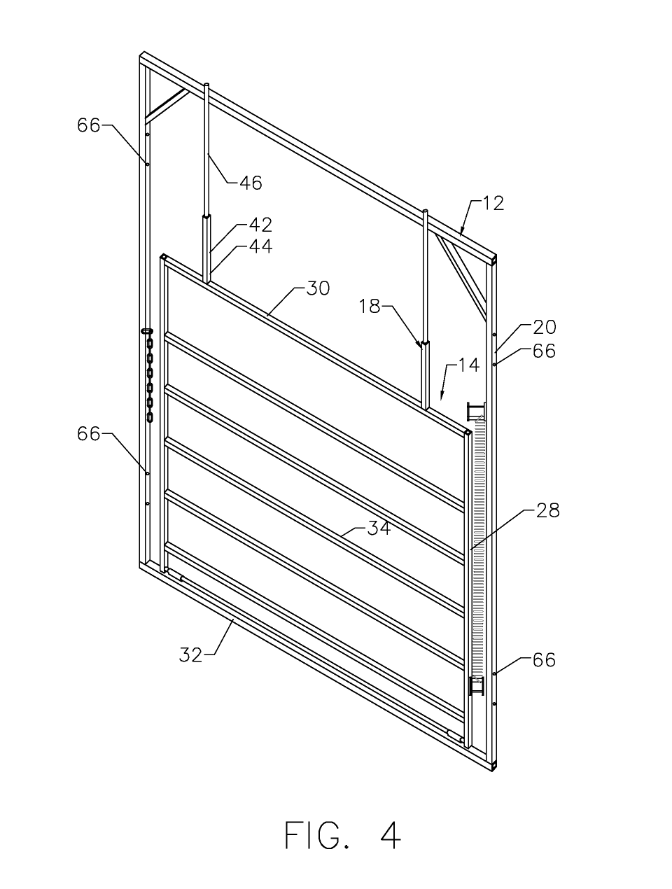

The gate 14 is provided with a flexible means 18, preferably attached to the gate top 30, for example, by welding, which is designed to slow the swing of the gate 14 through the frame 12 when the flexible means 18 comes in contact with the frame top 22. Preferably the flexible means 18 comprises at least two upright structures 42 (FIG. 4). Each flexible means 18 in the preferred embodiment extends from the gate top 30 to above the frame top 22 when the gate is in the upright position 40. Most preferably, each upright structure 42 comprises a rigid base 44, such as a piece of metal tubing, and a flexible upper extension 46. The flexible upper extensions 46 are sufficiently flexible so that when they are positioned on the same side of the gate frame 12 as the approaching vehicle, the flexible upper extensions 46 can bend enough to allow the gate 14 to he pushed downward from the upright position 40 to the opposite side of the gate frame 12. A material such as a flexible fiberglass rod or other flexible durable material as known in the art can thus be used for the flexible upper extensions 46. The length of the flexible means 18 in the preferred drive-through gate assembly 10 with dimensions given herein is preferably about 30 inches long. Other means to slow down the swing of the gate 14 through the frame 12 may be used.

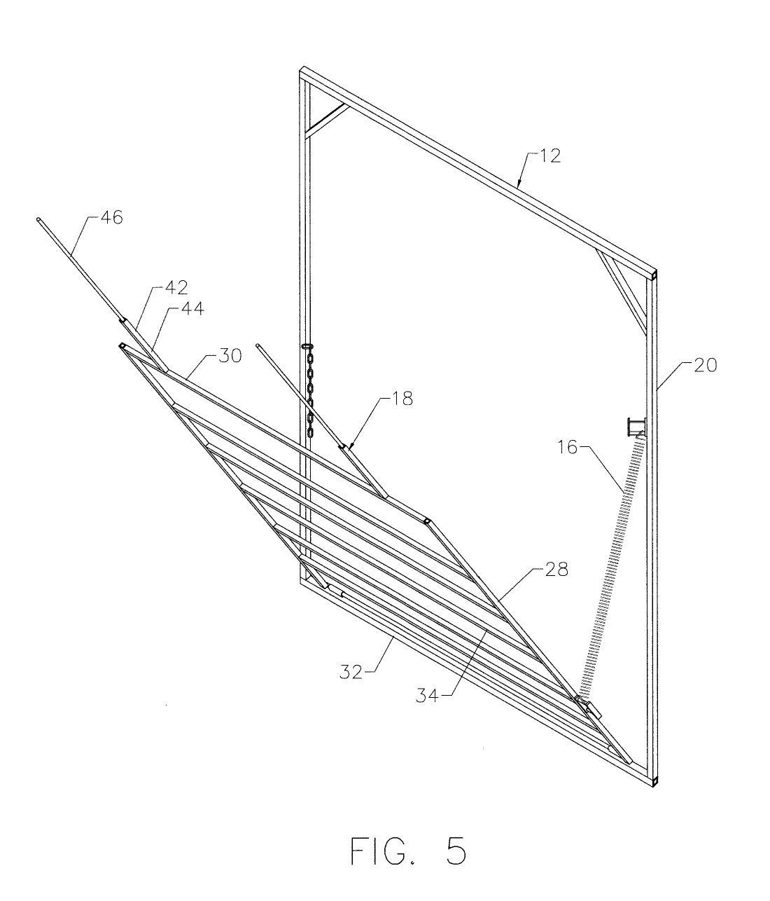

The drive-through gate assembly 10 further comprises a spring 16 (FIG. 5) attached at an upper spring end 48 to an upper position 50 on one of the frame sides 20, preferably about 27 inches from frame top 22. The spring 16 is preferably attached at a lower spring end 52 to a lower position 54 on one of the gate sides 28, preferably about 8 inches from frame bottom 24. The preferred spring 16 for the size gate preferred for use with ATVs is a spring such as a standard garage door spring (150 lb. spring).

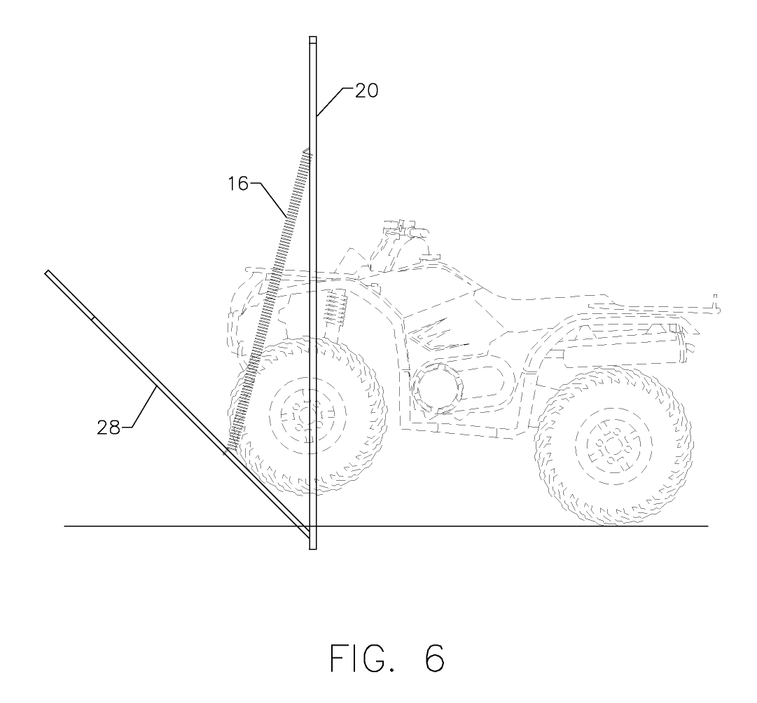

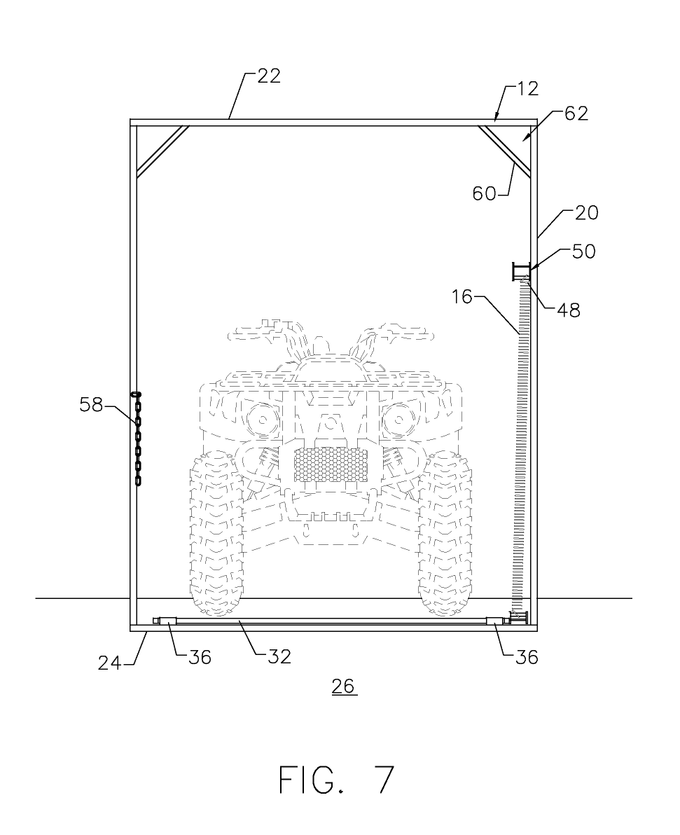

To use the drive-through gate assembly 10 of the invention herein, when a moving vehicle that is driven across the ground surface 26 on which the frame bottom 24 is positioned pushes against the gate 14 from either side of the gate assembly 10, the gate 14 is opened and pushed downward beneath the moving vehicle as the vehicle drives through the rectangular gate frame 12, pushing the gate 14 from its upright position 40 (FIG. 1 for example) to an angle position as shown in FIG. 6 to a horizontal gate position 38 as shown in FIG. 7. When the vehicle is driven off of the lowered gate 14, the gate 14 is no longer weighted down by the vehicle and is therefore automatically pulled upward by the spring 16 to the upright position 40 and is closed. The upward gate movement is slowed when it reaches the upright position 40 when the flexible means 18 come in contact with the frame top 22. Because the flexible means 18 is flexible, the gate 14 may swing slightly from one side of the frame 12 to another, with gate movement slowing as the flexible upper extensions 46 go from one side of the frame top 22 to the other side, ultimately stopping in an upright position 40.

Although not required for normal use of the invention herein, the drive-through gate assembly 10 may also include a chain holder 56 as known in the art. As shown in FIG. 1, such a chain holder 56 may be attached to one of the gate crossbars 34, or may be attached to the gate sides 28 as known in the art, and a chain 58 may be attached to the closest gate frame side 20 to the chain holder 56, for fastening the gate 14 immovably within the gate frame 12.

order to strengthen the drive-through gate assembly 10 of the invention, upper bracing means 60 may be provided across the corners 62 formed by the frame top 22 and the frame sides 20 as known in the art (FIG. 1). Other bracing means as desired may be used in addition or alternatively.

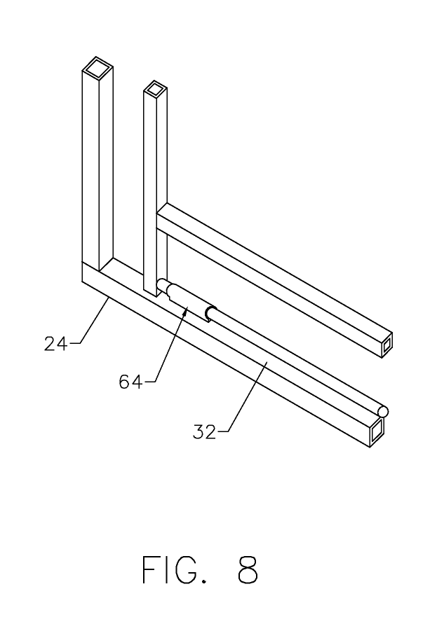

In the preferred embodiment, the means of hinging 36 the gate bottom to the frame bottom comprises two short tubular structures 64 attached to and extending upward from the frame bottom 24, through which tubular structures 64 the gate bottom 32 rotates when the gate 14 is opened and closed (FIG. 8). For standard use with ATVs, the two tubular structures 64 are preferably positioned apart on the frame bottom 24 a distance equal to a standard distance across an ATV between the ATV wheels or closer to the sides of the gate 14 (shown in FIG. 8). The tubular structures 64 may be made of metal or other materials known in the art. Although other means of hinging the gate bottom 32 to the frame bottom 24 may be used, it is important that the gate 14 be rotatable so that it can lie nearly flat on the ground surface 26 on either side of the gate frame 12, with the gate bottom 32 being contiguous with and on top of the frame bottom 24 to provide easy opening and closing of the gate 14 and improve the ride through the drive-through gate assembly 10.

Although the dimensions of the invention may be varied as desired, in the preferred embodiment as used for ATVs, preferably the gate frame 12 is about 76 inches high and about 64 inches wide and the gate 14 is about 48 inches high and about 54 inches wide. Also, although the materials of construction of the invention may be varied, preferably, the gate frame is made of 1-inch square metal tubing and the gate is made of ¾-inch square metal tubing, and the metal pieces are welded together to form the drive-through gate assembly 10.

In order that a vehicle may hold the gate 14 down as the vehicle drives across the gate 14, it is important that the gate crossbars 34 are sufficiently closely spaced so that the vehicle tires always are on one or more crossbars 34 and are never able to fall between the crossbars 34, which might allow the gate 14 to begin to lift up while the vehicle was above it. Therefore, with the preferred gate dimensions discussed herein, there are preferably sufficient crossbars 34 on the gate 14 so that the crossbars 34 are close enough so that as vehicle's tires hold the gate down as the vehicle progresses across the gate as well as being close enough to hold in any animals being held within the fenced area where the gate is placed. Preferably, for most uses, the crossbars 34 are about 7 inches apart. Preferably the gate crossbars 34 are parallel to the gate top 30 and the gate bottom 32. It is within the scope of the invention herein to provide other structures that serve as crossbars and extend between the gate sides 28, so long as they are sturdy enough to withstand repeated vehicle passage, do not interfere with vehicle passage, and are sufficiently closely placed so that a vehicle driven across the gate 14 holds the gate down.

The drive-through gate assembly 10 is attached to an appropriately sized opening in a fence 70 by any means known in the art so that the drive-through gate assembly 10 fills the opening. A preferred method of attachment to a fence is to have holes 66 in the frame sides (FIG. 4), through which holes 66 the gate frame 12 may be screwed to wooden or metal posts 68 (as shown in FIG. 1) placed at the sides of the opening in the fence.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A drive-through gate assembly, comprising:
a) a rectangular gate frame having two frame sides, a frame top and a frame bottom positioned on a ground surface;
b) a rectangular gate having two gates sides, a gate top, a gate bottom and a plurality of gate crossbars, the gate having dimensions so that it fits within the gate frame;
c) a means of hinging the gate bottom to the frame bottom with the gate being rotatable within the means of hinging the gate bottom to the frame bottom, from a gate position flat on the ground surface on one side of the gate assembly to an upright position to a gate position flat on the ground surface on the other side of the gate assembly;
d) a flexible means attached to the gate to slow movement of the gate when the gate comes to the upright position;
e) a spring attached at an upper spring end to an upper position on one of the frame sides and attached at a lower spring end to a lower position on one of the gate sides;
wherein when a moving vehicle that is driven across the ground surface on which the frame bottom is positioned pushes against the gate from either side of the gate assembly, the gate is opened and pushed downward beneath the moving vehicle as the vehicle drives through the rectangular gate frame, and when the vehicle is driven off of the gate, the gate is automatically pulled upward by the spring to the upright position and is closed, with gate movement being slowed when the gate reaches the upright position when the flexible means comes in contact with the frame top.

2. The drive-through gate assembly of claim 1, further comprising a chain holder attached to the gate sides and a chain attached to a closest gate frame for fastening the gate within the gate frame.

3. The drive-through gate assembly of claim 1, further comprising upper bracing means across corners formed by the frame top and the frame sides.

4. The drive-through gate assembly of claim 1, wherein the flexible means comprises at least two upright structures, each upright structure comprising a rigid base and a flexible upper extension, each flexible means extending from the gate top to above the frame top when the gate is in the upright position.

5. The drive-through gate assembly of claim 4, wherein each rigid base comprises metal tubing and each flexible upper extension comprises a fiberglass rod.

6. The drive-through gate assembly of claim 1, wherein the means of hinging the gate bottom to the frame bottom comprises two tubular structures extending upward from the frame bottom through which tubular structures the gate bottom rotates when the gate is opened and closed.

7. The drive-through gate assembly of claim 1, wherein the gate frame is about 76 inches high and about 64 inches wide and the gate is about 48 inches high and about 54 inches wide.

8. The drive-through gate assembly of claim 1, wherein the gate frame is made of 1-inch square metal tubing and the gate is made of ¾square metal tubing.

9. The drive-through gate assembly of claim 1, wherein the gate crossbars are parallel to the gate top and the gate bottom.

10. The drive-through gate assembly of claim 1, further comprising means to attach the frame sides to a fence structure.
